(19) United States
(12) Patent Application Publication
(10) Pub. No.: US 2023/0326282 A1
(43) Pub. Date: Oct. 12, 2023

(54) Banknote counting and conveying system for casinos

(71) Applicants: Tamir Morag, Bat Yam (IL); Aviv Antebi, Rosh HaAyin (IL)

(72) Inventors: Tamir Morag, Bat Yam (IL); Aviv Antebi, Rosh HaAyin (IL)

(21) Appl. No.: 17/705,329

(22) Filed: Mar. 27, 2022

(51) Int. Cl. G07D 11/40; G07D 11/00; G07D 11/16

(52) U.S. Cl. CPC G07D 11/40; G07D 11/009; G07D 11/16; G07D 2211/00; G07F 17/3246

(57) ABSTRACT

A banknote counting and conveying system that is designed to be assembled on a casino table and communicate with a safe that is positioned under that table. The system includes a tray on which the banknotes are placed after being counted. The tray has a leading slot that forms an upper opening of a vertical sleeve that is designed to be inserted into a banknote receiving slot in that table. The system includes a vertical push rod that is designed to push into the vertical sleeve through the leading slot the banknotes that are on the tray. The system also includes a pair of pulleys on the inner sides of the vertical sleeve that are designed to convey the banknotes from the leading slot downward into a banknote safe slot in the safe subsystem.

### TECHNICAL FIELD

The present invention relates to a banknote counting and conveying system for casinos.

### PRIOR ART

In casinos it is customary to place a safe subsystem (30) under casino gambling tables (20) that comprises a safe box (30a) that is inserted into s sleeve safe (30b) that is fixed under the casino table. The safe box and the sleeve safe has a narrow banknote safe slot (31) through which the bills are pushed into the safe subsystem by the casino workers that insert the bill through a banknote receiving slot (21) in the casino table. Casino tables and their safe subsystems are known and there is no need to detail these elements beyond the explanations above. The present invention describes a system that allows both the counting and conveying (insertion) the banknotes (100) into the safe subsystem in a convenient and efficient manner.

### BRIEF DESCRIPTION OF THE FIGURES

FIGS. 1 - 4 depict schematically the banknote counting and conveying system (10).

FIGS. 5A - 5C depict schematically the safe subsystem (30).

FIG. 6 depicts schematically the system (10) assembled on a casino table (20).

### THE INVENTION

The main objective of the present invention is to provide a banknote counting and conveying system (10) that is designed to be assembled on the casino table (20) and to communicate with the safe subsystem (30) that is positioned under the casino table

The banknote counting and conveying system (10) includes a tray (11) on which the banknotes can be placed in a stack after being counted. The tray has a leading slot (12) that forms an upper opening of a vertical sleeve (13) with a lower opening (14). The vertical sleeve is designed to be inserted into the existing banknote receiving slot (21) in the casino table.

The system (10) can be similar to banknote counting machines known today, and its structure does not require details as it is known to experts in the field. However, it should be noted that the system (10) includes the tray (11) on which the banknotes are placed in a stack after being counted, and that the tray has the leading slot (12) and the vertical sleeve (13) that is designed to be inserted or positioned above the existing banknote receiving slot (21) in the casino table. The leading slot (12) can be narrow and long enough to receive folded bills through it, similar to the slots on safes through which bills are inserted.

The banknote counting and conveying system (10) also includes a vertical push rod (15) (that can be telescopic) and an actuator (16) that is designed to lower and raise the vertical push rod. The vertical push rod is designed to push into the vertical sleeve through the leading slot the stack of banknotes that is on the tray.

The user, the casino employee, can place the bills in the designated place in the system, to count the bills that are conveyed to the tray where the bills are stacked in an orderly pile as usual. The bills are now laying in a stack on the try and then the vertical push rod can move downward and push the bills into the vertical sleeve through the leading slot.

The banknote counting and conveying system (10) also includes a pair of pulleys (17) (or a pair of straps) on the inner sides (131) (132) of the vertical sleeve The pair of pulleys is designed to convey the banknotes that are pushed into the leading slot downward into the banknote safe slot (31) in the safe subsystem.

The use of the vertical push rod together with the pair of pulleys enables efficient pushing of the bills into the safe subsystem. Using only a push rod would have required a longer rod to allow the bills to be fully inserted into the safe, and a longer rod would require a taller and larger machine, which is a disadvantage. The combination of a relatively short push rod (whose main function is to insert the bills into the leading slot) and pulleys that drive the bills into the safe are a combination that enables a compact and attractive machine.

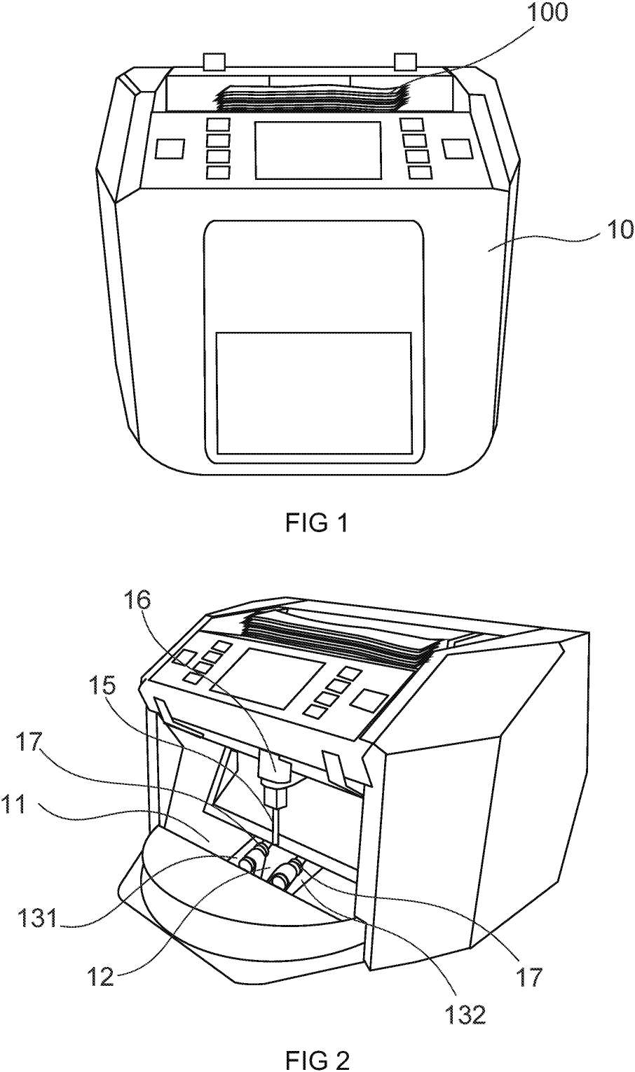

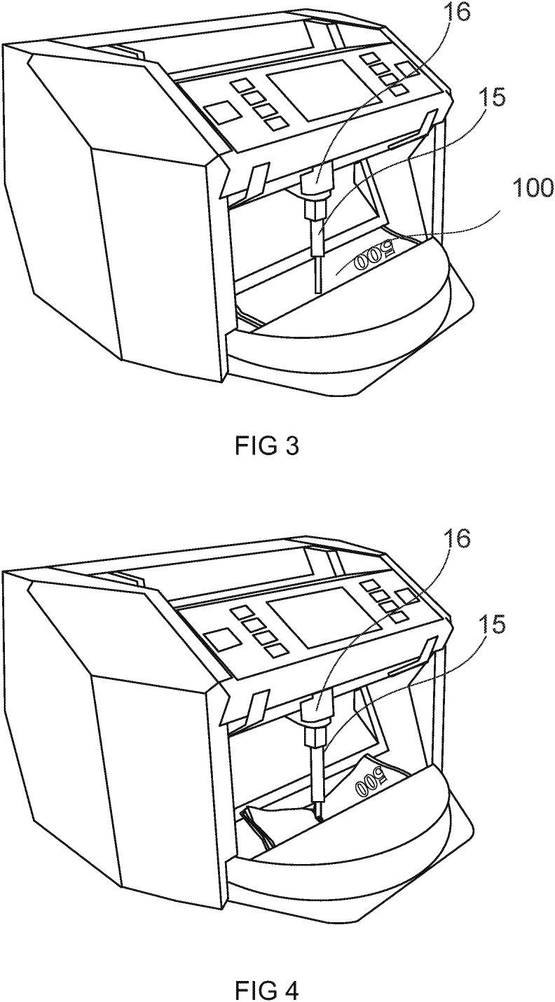

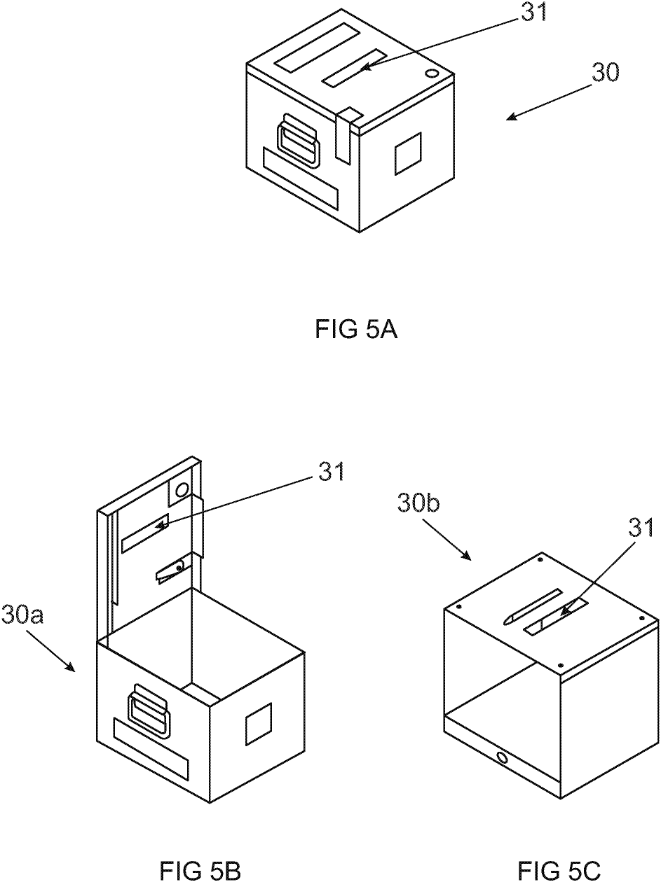

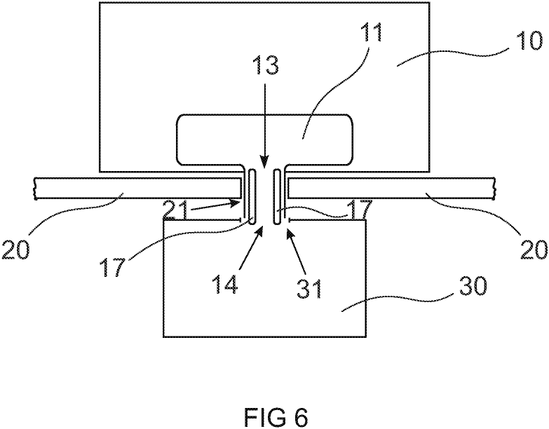

FIGS. 1 - 4 depict schematically the system (10), FIGS. 5A - 5C depict schematically the safe subsystem (30), and FIG. 6 depicts schematically the system (10) assembled on a casino table (20) and communicate with the safe subsystem.

What is claimed is:

1. A banknote counting and conveying system that is designed to be assembled on a casino table and to communicate with a safe subsystem that is positioned under the casino table;
wherein the banknote counting and conveying system includes a tray on which the banknotes can be placed in a stack after being counted, and wherein the tray has a leading slot that forms an upper opening of a vertical sleeve with a lower opening, wherein the vertical sleeve is designed to be inserted into a banknote receiving slot in the casino table;
wherein the banknote counting and conveying system further includes a vertical push rod and an actuator that is designed to lower and raise the vertical push rod, the vertical push rod is designed to push into the vertical sleeve through the leading slot the stack of banknotes that is on the tray,
wherein the banknote counting and conveying system further includes a pair of pulleys on the inner sides of the vertical sleeve, and wherein the pair of pulleys is designed to convey the banknotes that are pushed into the leading slot downward into a banknote safe slot in the safe subsystem.
